(19) United States
(12) Patent Application Publication
(10) Pub. No.: US 2006/0136338 A1
(43) Pub. Date: Jun. 22, 2006

(54) Techniques for filtering attempts to access component core logic

(75) Inventor: Moshe Maor, Kiryat Mozkin (IL)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/015,872

(22) Filed: Dec. 16, 2004

(51) Int. Cl. G06F 17/60

(52) U.S. Cl. 705/51

(57) ABSTRACT

Techniques to limit accesses to hardware component devices by external devices or external software programs. A filter device may be used to filter requests to access core logic of a hardware component device based on access rules. Access rules can limit access to the core logic based on phases of the hardware component device, the requested operation of the core logic, or the target area in the core logic.

### FIELD

The subject matter disclosed herein relates to techniques to maintain security in hardware peripherals of a computer system.

### RELATED ART

In a computing environment, malicious software such as viruses and worms are prevalent. Malicious software typically seeks to disrupt or take control of the operation of a computer or its peripheral hardware components. For example, hardware components that are capable of receiving commands through a PCI compatible bus expose their configuration and status registers to manipulation by devices connected to the bus but do not impose any protection against any subset of allowed transactions. It is desirable to prevent malicious software from manipulating operation and configuration of hardware components.

### BRIEF DESCRIPTION OF THE DRAWINGS

FIG. 1 depicts a system in which some embodiments of the present invention may be used.

FIG. 2 depicts an example computer system that can use embodiments of the present invention.

FIG. 3 depicts an example implementation of a HW component that includes the capability to filter read or write requests from external devices, in accordance with an embodiment of the present invention.

FIG. 4 provides an example access map by which configuration and status registers may be available for access or not, in accordance with an embodiment of the present invention.

FIG. 5 depicts an example implementation of network interface, in accordance with an embodiment of the present invention.

FIG. 6 depicts an example process that can be used to control whether an external device or routine is permitted to access core logic of a hardware component of a computer system, in accordance with an embodiment of the present invention.

Note that use of the same reference numbers in different figures indicates the same or like elements.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

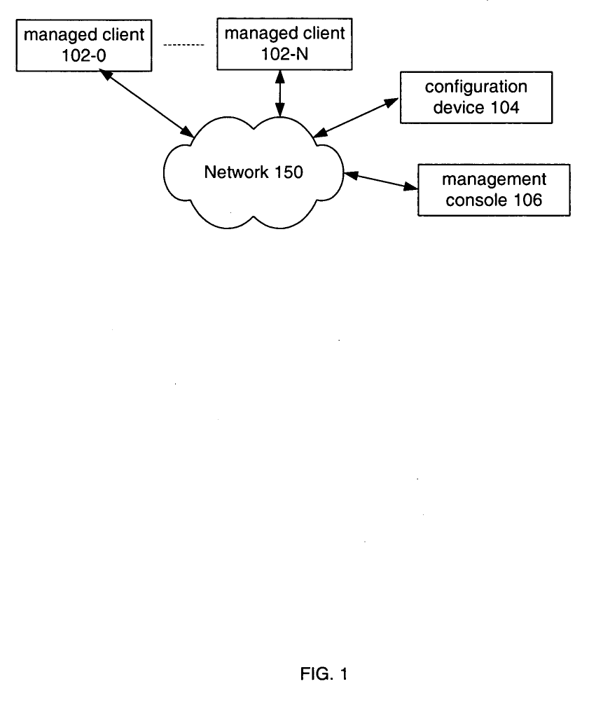

For example, FIG. 1 depicts a system in which some embodiments of the present invention may be used. The system may include managed client devices 102-0 to 102-N, configuration device 104, and management console 106. Managed client devices 102-0 to 102-N, configuration device 104, and management console 106 may communicate using network 150.

Network 150 may be any network such as the Internet, an intranet, a local area network (LAN), storage area network (SAN), a wide area network (WAN), or wireless network. Network 150 may exchange traffic with computer system using the Ethernet standard, SONET/SDH, ATM, or any communications standard.

For example, any of managed client devices 102-0 to 102-N may be implemented as any computer such as a personal computer or server computer. In one embodiment, any of managed client devices 102-0 to 102-N may provide to management console 106 information such as, but not limited to, data or inventory (e.g., hardware or software) in each of managed client devices 102-0 to 102-N as well as other information related to suspected hardware failures and boot-up records. In one embodiment, any of managed client devices 102-0 to 102-N may have the ability to limit the extent to which software routines or hardware device can control their use or access information stored therein.

Configuration device 104 may provide a directory of managed client devices and a protocol for communication between management console 106 and any of managed client devices 102-0 to 102-N. For example, to provide communication, configuration device 104 may utilize Dynamic Host Configuration Protocol (DHCP) and/or Domain Name System (DNS) protocol, although other protocols may be used. In one embodiment, management console 106 and configuration device 104 may be combined into a single device.

Management console 106 may provide capability to a user to view information such as, but not limited to, data or inventory (e.g., hardware or software) in each of managed client devices 102-0 to 102-N as well as other information related to suspected hardware failures and boot-up records. Management console 106 may provide capability to a user to monitor any of managed client device 102-0 to 102-N regardless of the state of the operating system or power-mode of any of managed client devices 102-0 to 102-N. In one embodiment, management console 106 may intercommunicate with each of managed client devices 102-0 to 102-N via Extensible Markup Language (XML) scripts, although other protocols may be used. In one embodiment, configuration device 104 and management console 106 may be combined into a single device.

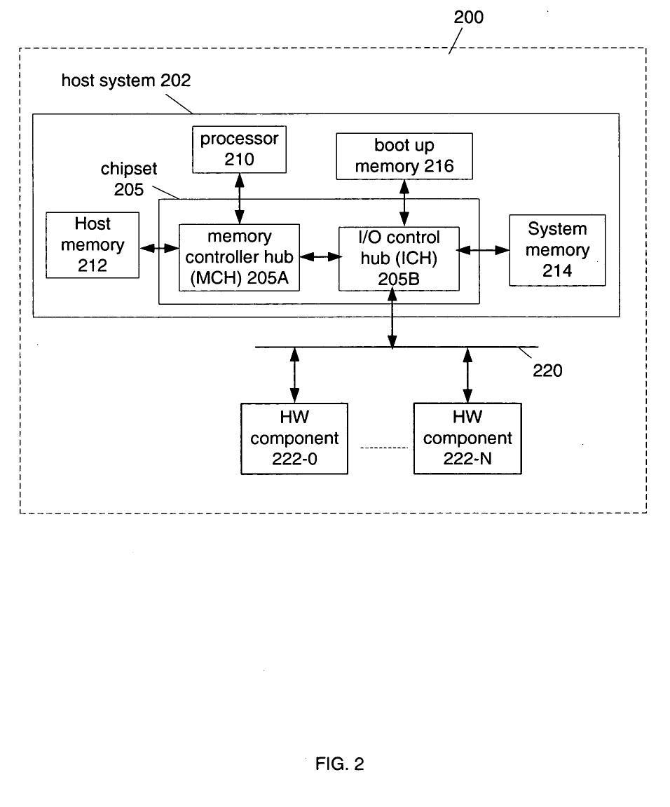

FIG. 2 depicts in computer system 200 a suitable implementation of any of managed client devices 102-0 to 102-N. Computer system 200 may include chipset 205, processor 210, host memory 212, system memory 214, boot-up memory 216, bus 220, and hardware (HW) components 222-0 to 222-N.

Chipset 205 may include a memory controller hub (MCH) 205A that may provide intercommunication among processor 210 and host memory 212 as well as a graphics adapter that can be used for transmission of graphics and information for display on a display device (both not depicted). Chipset 205 may further include an I/O control hub (ICH) 205B that may intercommunicate with MCH 205A and may provide intercommunication among system memory 214, boot up memory 216, and bus 220.

Processor 210 may be implemented as a Complex Instruction Set Computer (CISC) processor or Reduced Instruction Set Computer (RISC) processor, multi-core, or any other microprocessor or central processing unit. Host memory 212 may be implemented as a volatile memory device (e.g., Random Access Memory (RAM), Dynamic Random Access Memory (DRAM), or Static RAM (SRAM)). System memory 214 may be implemented as a non-volatile storage device such as a magnetic disk drive, optical disk drive, tape drive, an internal storage device, an attached storage device, and/or a network accessible storage device. Routines and information stored in system memory 214 may be loaded into host memory 212 and executed by processor 210. For example, system memory 214 may store an operating system as well as applications used by system 200.

Boot-up memory 216 may be implemented as a non-volatile memory such as read only memory (ROM), Erasable Programmable ROM (EPROM), Electrically Erasable Programmable ROM (EEPROM), Masked ROM, or flash memory. Boot-up memory 216 may at least store a basic input/output system (BIOS) and an asset description of a managed client device. In one embodiment, during the boot-up of system 200, BIOS may determine the asset description as well as a boot record. For example, the asset description may include, but not be limited to, make/model of the managed client device, serial number of processor 210, storage size of host memory, storage size of system memory 214, plug-and-play ID list (e.g., list of hardware peripherals either by serial number of by a general name). Some asset description may be hard coded whereas some may be measured during boot-up (e.g., storage size of host memory, storage size of system memory 214, plug-and-play ID list). The boot record of system 200 may include suspected hardware failures or indicators measured during the boot-up process (e.g., host memory check, storage device check, and indication of invalid boot sector in a storage device).

Bus 220 may provide intercommunication among host system 202 and HW components 222-0 to 222-N. Bus 220 may support node-to-node or node-to-multi-node communications. Bus 220 may be compatible with Peripheral Component Interconnect (PCI) described for example at Peripheral Component Interconnect (PCI) Local Bus Specification, Revision 2.2, Dec. 18, 1998 available from the PCI Special Interest Group, Portland, Oreg., U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.0a, Jul. 24, 2000, available from the aforesaid PCI Special Interest Group, Portland, Oreg., U.S.A. (as well as revisions thereof); serial ATA described for example at “Serial ATA: High Speed Serialized AT Attachment,” Revision 1.0, published on Aug. 29, 2001 by the Serial ATA Working Group (as well as related standards); Universal Serial Bus (USB) (and related standards); as well as other interconnection standards.

HW components 222-0 to 222-N may be any device capable of receiving information or instruction from host system 202 or providing information or instruction to host system 202. Any of HW components 222-0 to 222-N may be capable of providing information or instruction to another of HW components 222-0 to 222-N or receiving information or instruction from another of HW components 222-0 to 222-N. Any of HW components 222-0 to 222-N may include the capability to prevent access requests (e.g., instructions, read, or write requests) from external devices such as host system 202 from transfer to the HW component's core logic, in accordance with an embodiment of the present invention. Core logic of HW components 222-0 to 222-N may include microchips or integrated circuits interconnected using conductive leads of a motherboard, hardwired logic, software stored by a memory device and executed by a microprocessor, firmware, an application specific integrated circuit (ASIC), a memory or storage device, and/or a field programmable gate array (FPGA).

Computer system 200 may be implemented as any or a combination of: microchips or integrated circuits interconnected using conductive leads of a motherboard, hardwired logic, software stored by a memory device and executed by a microprocessor, firmware, an application specific integrated circuit (ASIC), and/or a field programmable gate array (FPGA).

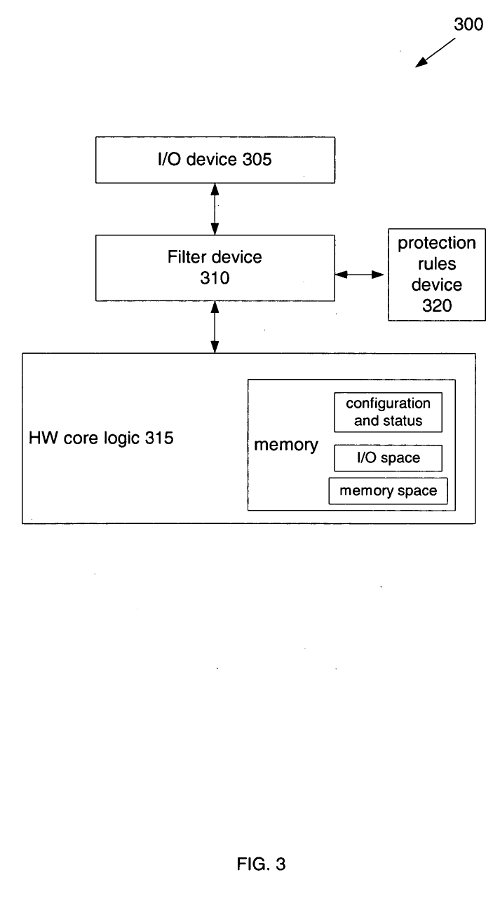

For example, FIG. 3 depicts an example implementation of a HW component 300 that includes the capability to filter read or write requests from external devices such as, but not limited to, host system 202, in accordance with an embodiment of the present invention. HW component 300 may include I/O device 305, filter device 310, HW core logic 315, and protection rules device 320.

I/O device 305 may provide intercommunication between filter device 310 and a host system interface such as, but not limited to, bus 220 by providing a medium attachment and by supporting relevant protocols of the interface.

Filter device 310 may filter attempts to access HW core logic 315 transferred by I/O device 305 (e.g., from an interface) based on rules provided by protection rules device 320. For example, the attempt to access may include an instruction type (e.g., read or write), the address of the target HW component, a function in the target HW component to access, as well as an address in memory of HW component 300 to be accessed. For example, protection rules device 320 may program filter device 310 to recognize access attempts that should or should not be transferred to HW core logic 315. Accordingly, filter device 310 may protect the HW core logic 315 from being configured in a wrong or harmful manner such as configuration by a faulty driver or a virus.

In one embodiment, protection rules device 320 may direct filter device 310 to filter access attempts based on the type of access attempt (e.g., read or write), memory sector in a memory of HW core logic 315 requested to be accessed (e.g., configuration and status register space, I/O space, or memory space), and/or originator of the access attempt (as the case may be), although other criteria can be used.

In one embodiment, protection rules device 320 may configure filter device 310 to be capable of entering multiple phases (e.g., trusted or untrusted), whereby in each phase, the extent to which filter device 310 transfers instructions to HW core logic 315 is reduced. For example, in a trusted phase, filter device 310 may transfer to HW core logic 315. any instructions received from I/O device 305 and provided by external trusted source(s). For example, in an untrusted phase, filter device 310 may not transfer to HW core logic 315 any instructions received from I/O device 305. Accordingly, to the extent that code which may be malicious attempts to control HW core logic 315 during the untrusted phase, access to HW core logic 315 may be denied. For example, HW core logic 315 may respond to instructions received during the untrusted phase by ignoring the instruction or providing a pre-programmed generic response.

In one embodiment, triggering events may change a state of filter device 310 from a trusted phase to an untrusted phase and vice versa. Triggering events detectable by filter device 310 that cause it to enter the trusted phase include platform events which no software component can trigger and which cause the very next step to be execution of a trusted source. For example, a triggering event causing filter device 310 to enter a trusted phase may include a PCI-reset de-assertion event in the host system. Under PCI, after a PCI-reset de-assertion event occurs, the processor is reset and the next step is for the processor to execute BIOS code. For example, power-up or restoration of full-power of the host system may trigger a PCI-reset de-assertion event. Other triggering events may be used. For example, a triggering event causing entrance to the untrusted phase includes a trusted source (such as a BIOS) notifying that an untrusted source will next be executed. For example, a BIOS notification prior to running code that is off-BIOS code may trigger entering the untrusted phase.

For example, a trusted source may include a BIOS code prior to requesting that code be executed that is off-BIOS. Off-BIOS code may include, but not be limited to, code in a memory other than boot up memory 216; operating system (such as Linux, DOS, or Windows); or any third party “ROM extension” code that the BIOS can request be executed. Examples of third party ROM extension code include, but are not limited to: code used by Small Computer Systems Interface (SCSI) adapters to initialize SCSI adapters and Pre-boot Execution Environment (PXE) code enabling an operating system (OS) to be loaded from a network using network interface. Other trusted sources may include software that can not be added except by a trusted source or authorized person and after added, cannot be subsequently changed except by a trusted source or authorized person.

In one embodiment, filter device 310 may be capable of entering multiple levels of trust. For example, there may be a trusted phase, semi-trusted phase, and an untrusted phase. During the semi-trusted phase, the HW component may execute a limited set of instructions or execute instructions issued by a limited set of sources. For example, a link “up” scenario (described later) may correspond to a semi-trusted phase. For example, a source may identify itself by a source identifier in the access request.

Other example triggers that may cause a movement to a trusted or semi-trusted phase include a non-maskable interrupt (NMI) and system management interrupt (SMI). An NMI may trigger a host processor to next execute a BIOS and thereby cause movement to a trusted phase. An NMI may trigger a host processor to next execute less trusted code than the BIOS such as an OS kernel and thereby cause movement to a semi-trusted phase whereby a limited set of instructions from the OS kernel may be transferred to the HW core logic for execution. An SMI may trigger a host processor to next execute a BIOS and so cause movement to a trusted phase. Further examples of OS and BIOS instructions that may be transferred to core logic include storing a user's key stroke during login.

In one embodiment, a remote entity such as a remote server (e.g., a management console) or a trusted source in the host system may set rules in protection rules device 320 that are to be applied by filter device 310. For example, the remote server may change rules based on the system status of the HW component. Examples of HW component system status include the power use state of the HW component. For example, the remote server may change rules based on the system status of the host system. Examples of host system status include: Advanced Configuration and Power Interface (ACPI) specification compliant power use states of the host system (e.g., on, off, sleep, hibernate, or standby) or power states of each of the components of the host system such as the power use state of the host system processor.

In one embodiment, protection rules device 320 may limit access by external instructions to certain functions of the HW core logic 315 (e.g., a host interface capability, described later) during phases (such as during semi-trusted phases or untrusted phases) or for time periods.

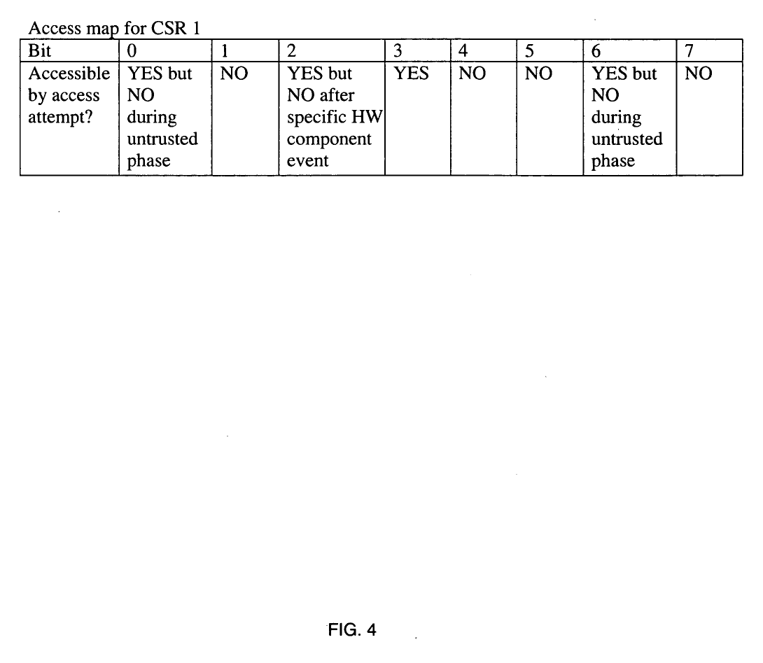

For example, FIG. 4 provides an example access map associated with a configuration and status register (CSR 1) of a HW component. The access map can be configured to permit access or deny access to CSR 1 on a bit level, in accordance with an embodiment of the present invention. For example, CSR 1 may include 8 bits (0 to 7) and each bit is designated as being accessible or not accessible by an access request. For example, bits 1, 4, 5, and 7 may be designated as not accessible by any access attempt. Bits 0 and 6 may be accessible except during an untrusted phase. Bit 2 may be accessible except after a specific HW component state such as a link with a network node is enabled. Bit 3 may be accessible regardless of any conditions. Accordingly, configuration registers may be protected from access conditional to events in the HW component or the host system or unconditionally. This is merely one example of an access map; many other types and configurations can be used. The access map may be stored in protection rules device 320. Accordingly, filter device 310 may filter a request to access the CSR 1 based on the access map. For example, HW core logic 315 may include multiple functions, each function with its own associated CSR and access map such that an access map specifies access of a CSR associated with each function.

For example, one possible response to an impermissible read request is to provide pre-defined data instead of the actual data. For example, if an impermissible access attempt requests to read a specific register that holds the data value 0x10101010, filter device 310 may provide in response to the impermissible access attempt, a pre-defined response value of 0x00000000. For example, one possible response to an impermissible write request is to ignore the write request. For example, for a write transaction transmitted over a PCI compatible bus, ignoring the write transaction does not trigger an error condition. The source of the impermissible write transaction may believe that the HW component is complying with the impermissible write request even though the HW component does not. In one embodiment, when an impermissible requests _{[0]} occurs, filter device 310 may generate an alert message to be sent to an external device such as a management console to notify the management console of an impermissible request as well as the nature of the impermissible request.

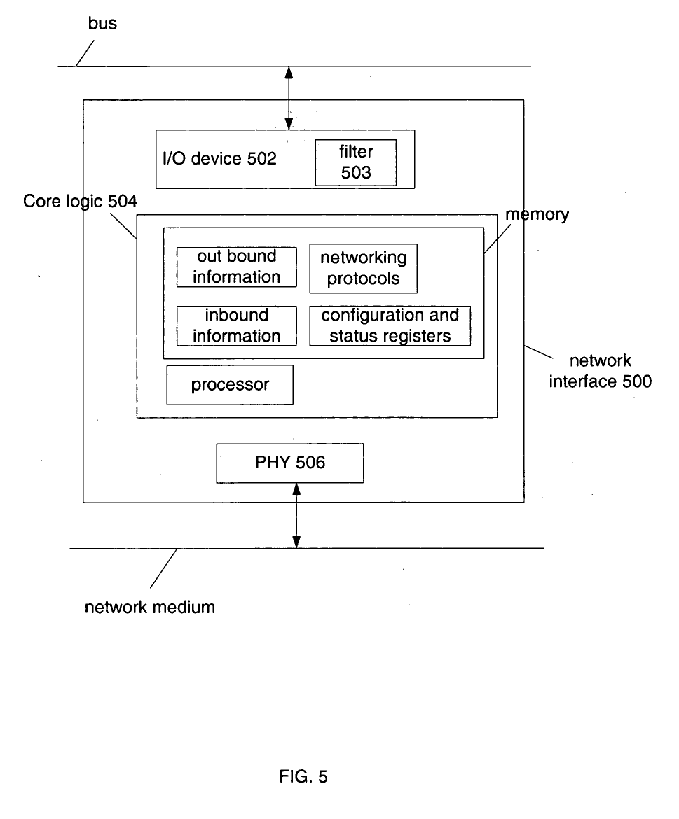

HW core logic 315 may provide the core functionality of the HW component. HW core logic 315 may include microchips or integrated circuits interconnected using conductive leads of a motherboard, hardwired logic, software stored by a memory device and executed by a microprocessor, firmware, an application specific integrated circuit (ASIC), a memory or storage device, and/or a field programmable gate array (FPGA). For example, the memory device may store configuration and status registers (CSR). Configuration and status registers (CSR) may be used to configure the operations of the functions that can be performed by HW core logic 315 or HW component 300 in general. For example, selected contents of configuration and status registers (even at the bit level) may be marked in access maps as accessible or not-accessible by access attempts. For example, functions that can be performed by HW component 300 include but are not limited to a host interface, link connection, and host system asset information receipt or transfer capabilities (each described with respect to FIG. 5).

HW component 300 may be implemented as any or a combination of: microchips or integrated circuits interconnected using conductive leads of a motherboard, hardwired logic, software stored by a memory device and executed by a microprocessor, firmware, an application specific integrated circuit (ASIC), and/or a field programmable gate array (FPGA).

In one embodiment, at least one of HW components 222-0 to 222-N can be implemented as a network interface. For example, the network interface may be capable of providing intercommunication between a computer system (including but not limited to computer system 200) and a network (such as but not limited to network 150) in compliance with the relevant network standards such as, but not limited to, Ethernet or SONET/SDH.

For example, FIG. 5 depicts an example implementation of network interface 500 in accordance with an embodiment of the present invention. Network interface 500 may include I/O device 502, core logic 504, and physical layer interface (PHY) 506. I/O device 502 may provide intercommunication between a host system bus (including but not limited to bus 220) and network interface 500. For example, I/O device 502 may encode and provide communications to the bus and receive and decode communications provided by the bus, both in accordance with the standards used by the bus. I/O device 502 may utilize filter 503 to filter requests from the bus in a similar manner as those described with respect to filter device 310 and protection rules device 320.

In one embodiment, as depicted, core logic 504 may include a processor capable of executing instructions and a memory device. In one embodiment, core logic 504 may include microchips or integrated circuits interconnected using conductive leads of a motherboard, hardwired logic, software stored by a memory device and executed by a microprocessor, firmware, an application specific integrated circuit (ASIC), a memory or storage device, and/or a field programmable gate array (FPGA).

Core logic 504 may include a capability to provide a host interface that provides intercommunication between network interface 500 and at least a BIOS utilized by a host system. The interface may be implemented as a KCS interface defined in the Intelligent Platform Management Interface (IPMI) standard running over a PCI compatible bus. In one embodiment, the host interface capability of network interface 500 may be made available for access during a trusted phase.

For example, during a trusted phase, filter 503 may permit a BIOS in a host system to access the host interface capability of I/O device 502 and thereby permit the memory to receive information during a trusted phase that is provided by the BIOS of a host system such as hardware or software asset information or information related to boot-up records. Accordingly, information transferred during the trusted phase may be relied upon as uncorrupted. For example, a device such as management console 106 may request information from a host system (such as but not limited to host system 202) by providing the request to network interface 500. In one embodiment, management console 106 may request hardware or software asset description information or boot-up records of the host system from network interface 500 using an XML compatible communication. Accordingly, information concerning the host system may be transferred to a device such as management console 106 regardless of the operating system or power-use state of the host system by providing the information to network interface 500 for storage and transfer.

In one embodiment, configuration and status registers stored in memory of core logic 504 can be used to configure network interface 500 to permit communications with one or more specified node addresses in the network. After communications with a specified node address has been established, filter 503 may be configured to not permit any change to the configuration except when made by specified sources. For example, a status register may indicate whether communications with a specified node address is active and filter 503 may monitor the status register to determine whether communications with a specified node address is active (e.g., link up/link down status). For example, if the link status is “down”, an external device or software routine may be permitted to reconfigure the link. For example, reconfiguring the link may involve changing the specified node address. For example, if the link status is “up”, filter 503 may prohibit any change to the link configuration except by specified sources. A link status of “up” may involve configuration of PHY 508 to communicate with the specified node address. Accordingly, if the specified node address is a management console, after the link is “up”, the link between the management console and network interface 500 may be prevented from being disrupted or altered except by a specified source. Accordingly, a secure link may be provided to transfer information such as asset information and boot up records of the host system.

Memory of core logic 504 may store applications and protocols used by network interface 500 to communicate with external devices through the network such as, but not limited to, management console 106. The memory may store contents of packets and frames received from the network as well as contents of packets and frames to be transferred to the network. For example, the memory may store information to be transferred to the host system or outbound information to be transferred from the host system to the external device. For example, information may include, but is not limited to, asset information, boot up records, key stroke information (such as key strokes provided in response to a login request) of the host system.

Processor of core logic 504 may encode packets or frames to be transmitted to the network in conformance with relevant networking protocols such as Ethernet or SONET/SDH, although other protocols may be supported. Similarly, the processor may decode packets or frames received from the network in conformance with relevant networking protocols such as Ethernet or SONET/SDH, although other protocols may be supported.

PHY 506 may provide network interface 500 access to a network medium of a network to support transmission and receipt of packets and frames between the network and network interface 500. The network may be any network such as the Internet, an intranet, a local area network (LAN), storage area network (SAN), a wide area network (WAN), or wireless network. The network may exchange traffic with network interface 500 in conformance with the Ethernet standard, SONET/SDH, ATM, or any communications standard.

Network interface 500 may be implemented as any or a combination of: microchips or integrated circuits interconnected using conductive leads of a motherboard, hardwired logic, software stored by a memory device and executed by a microprocessor, firmware, an application specific integrated circuit (ASIC), and/or a field programmable gate array (FPGA). For example, network interface 500 may be integrated into a chipset (such as but not limited to chipset 205) in a LAN-on-motherboard implementation; implemented as a network interface card that can be plugged into a bus interface in a motherboard platform that provides intercommunication with the computer system (such as but not limited to chipset 205); and/or in part be implemented using a host processor.

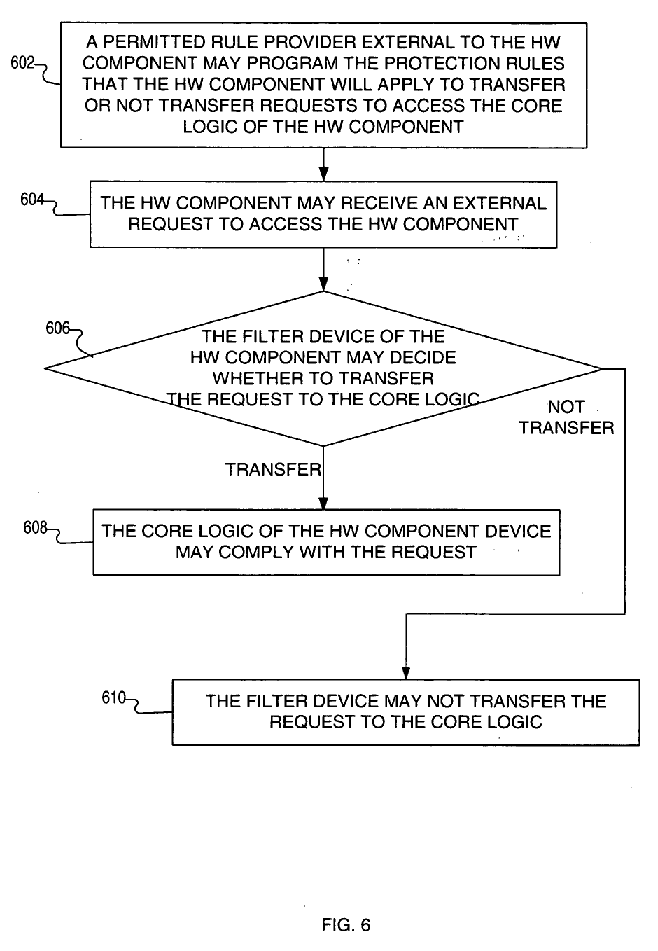

FIG. 6 depicts an example process that can be used in embodiments of the present invention to control whether an external device or routine is permitted to access core logic of a hardware component of a computer system. In block 602, a permitted rule provider external to the HW component may program the protection rules that the HW component applies to transfer or not transfer requests to access the core logic of the HW component. For example, a remote server or a trusted source in the host system may be permitted to program the protection rules. Block 602 may apply rules similar to those described with respect to protection rules device 320, although other rules may be applied.

In block 604, the HW component may receive an external request to access the HW component. For example, a request to access the HW component may include a request to read information from the HW component core logic, write information to the HW component core logic, or otherwise instruct the HW component core logic. One possible example of HW component core logic is described with respect to FIG. 3 as HW core logic 315, although other possible implementations of HW component core logic may be used.

In block 606, the filter device of the HW component may decide whether to transfer the request to the HW component core logic. For example, the filter device may decide to transfer the request based upon rules programmed in block 602. If the HW component decides to transfer the request, block 608 may follow block 606. If the HW component decides not to transfer the request, block 610 may follow block 606.

In block 608, the core logic of the HW component device may comply with the external request. In block 610, the filter device may not transfer the request to the core logic. For example, the filter device may ignore the request or issue a pre-defined dummy response, depending on the applicable rules for responding to a request (e.g., response time or error deductions from no response). For example, one possible response to an impermissible read request is to provide pre-defined data instead of the actual data. For example, if an impermissible access attempts to read a specific register that holds the data value of 0x10101010, in block 610, in response to the impermissible access attempt, a pre-defined response value of 0x00000000.

Modifications

The drawings and the forgoing description gave examples of the present invention. Although depicted as a number of disparate functional items, those skilled in the art will appreciate that one or more of such elements may well be combined into single functional entities. Alternatively, certain elements may be split into multiple functional elements. The scope of the present invention, however, is by no means limited by these specific examples. Numerous variations, whethet explicitly given in the specification or not, such as differences in structure, dimension, and use of material, are possible. The scope of the invention is at least as broad as given by the following claims.

What is claimed is:

1. A method comprising:
at a hardware component, storing access rules; and
at the hardware component, selectively filtering requests to access core logic of the hardware component based on the access rules.

2. The method of claim 1, wherein the storing access rules comprises:
receiving access rules from an external source.

3. The method of claim 1, wherein the hardware component includes a memory and wherein the rules comprise rules to limit access to specified contents of the memory.

4. The method of claim 1, wherein
the hardware component includes capability to provide intercommunication with a network,
the hardware component stores configuration and status registers for the capability to provide intercommunication with the network, and
the rules limit modification of configuration and status registers after a communications link between the hardware component and a node in the network is established.

5. The method of claim 1, wherein
the hardware component includes a capability to provide intercommunication with a network and a capability to interface with a host computer, and
the rules permit the host computer to transfer asset information and boot up records of the host computer during a specified phase using the interface for storage by the hardware component.

6. The method of claim 1, wherein
the hardware component stores configuration and status registers, and
the rules comprise limiting modification of specified portions of configuration and status registers.

7. The method of claim 1, wherein the selectively filtering requests comprises providing a predefined response to an impermissible read request.

8. The method of claim 1, wherein the selectively filtering requests comprises not transferring an impermissible write request to core logic of the hardware component.

9. An apparatus comprising:
a hardware component comprising:
an I/O device;
core logic;
a protection rules device to store access rules; and
a filter device responsive to access requests transferred from the I/O device and
to selectively filter requests to access the core logic based in part on the access rules.

10. The apparatus of claim 9, wherein the protection rules device to store access rules is to receive access rules from a source external to the hardware component.

11. The apparatus of claim 9, wherein the core logic includes a memory device and wherein the rules comprise limiting access to specified contents of the memory device.

12. The apparatus of claim 9, wherein
the core logic includes a memory,
the core logic includes capability to provide intercommunication with a network,
the memory stores configuration and status registers for the capability to provide intercommunication with the network, and
the rules limit modification of configuration and status registers after a communications link between the hardware component and a node in the network is established.

13. The apparatus of claim 9, wherein
the core logic includes a memory,
the core logic includes a capability to provide intercommunication with a network and a capability to interface with a host computer, and
the rules permit the host computer to transfer asset information and boot up records of the host computer during a specified phase using the interface for storage by the memory.

14. The apparatus of claim 9, wherein
the core logic includes a memory,
the memory stores configuration and status registers, and
the rules limit modification of specified portions of configuration and status registers.

15. The apparatus of claim 9, wherein the filter device is to provide a predefined response to an impermissible read request.

16. The apparatus of claim 9, wherein the filter device is to not transfer to the core logic an impermissible write request.

17. A method comprising:
receiving a request at a network interface through a network from a management console for information related to a host system, wherein the network interface is capable of intercommunicating with the host system;
at the network interface, storing access rules, wherein the access rules control the extent to which the network interface transfers requests from the host system to access core logic of the network interface;
at the network interface, selectively filtering requests to access the core logic based on the access rules;
at the network interface, storing information relating to the host system in the core logic, wherein the access rules permit storage of information related to the host system in the core logic during a specified phase; and
transferring the information to the management console through the network.

18. The method of claim 17, wherein the management console comprises a computer that provides a user with capability to view information of at least one managed client device, wherein at least one managed client device includes the host system.

19. The method of claim 17, wherein the information includes asset information of the host computer.

20. The method of claim 17, wherein the information includes boot up records of the host computer.

21. A system comprising:
a network interface capable of providing intercommunication between a network and a host system comprising:
an I/O device,
core logic,
a protection rules device to store access rules, and
a filter device responsive to access requests transferred from the I/O device and to selectively filter requests to access the core logic based in part on the access rules; and
a bus interface to permit intercommunication between the host system and the network interface.

22. The system of claim 21, wherein the bus interface complies with PCI.

23. The system of claim 21, wherein the bus interface complies with PCI express.

24. A system comprising:
at least one managed client device, wherein the managed client device comprises:
an I/O device,
core logic,
a protection rules device to store access rules, and
a filter device responsive to access requests transferred from the I/O device and to selectively filter requests to access the core logic based in part on the access rules; and
a management console configured to communicate with the at least one managed client device using a network.

25. The system of claim 24, wherein during a phase specified by the access rules, the filter device transfers information of a host system for storage into the memory device.

26. The system of claim 25, wherein the information comprises asset information of a host system.

27. The system of claim 25, wherein the information comprises a boot record of a host system.
